(19) United States
(12) Patent Application Publication
(10) Pub. No.: US 2014/0258497 A1
(43) Pub. Date: Sep. 11, 2014

(54) MANAGEMENT SYSTEM FOR AUTOMATIC DOOR APPARATUS

(71) Applicant: NABTESCO CORPORATION, Tokyo (JP)

(72) Inventors: Yoshinari Kiyomasa, Muskego, WI (US); Alan Kettering, Muskego, WI (US)

(21) Appl. No.: 14/350,031

(22) PCT Filed: Oct. 4, 2012
(86) PCT No.: PCT/US12/58702

§ 371 Date: Apr. 4, 2014

Related U.S. Application Data
(60) Provisional application No. 61/544,142, filed on Oct. 6, 2011.

(51) Int. Cl. G05B 23/00; H04L 12/26

(52) U.S. Cl. CPC G05B 23/00; H04L 43/50
USPC 709/223

(57) ABSTRACT

Provided are a management system and management method for an automatic door apparatus, with which it is possible to easily recognize the working circumstances of an automatic door apparatus and also possible to easily ensure security without incurring management costs for a selling company or a maintenance company. A management system for automatic door apparatuses comprises: the automatic door apparatuses with which communication is possible; a management server disposed within a narrow-area network of the customer-side management system identical to the automatic door apparatuses and capable of checking the working circumstances of the automatic doors by communicating with the automatic door apparatuses; and a management PC disposed within a wide-area network outside the narrow-area network and capable of communicating with the management server by remote desktop technology; wherein the management PC acquires the working circumstances of the automatic door apparatuses via the management server.

### TECHNICAL FIELD

The present invention relates to a management system for an automatic door apparatus adapted for maintaining and managing an automatic door apparatus.

### BACKGROUND ART

In recent years, there have been developed a variety of different techniques for easily performing maintenance in the management of an automatic door apparatus. For example, Patent Literature 1 discloses a management method and management system for an automatic door apparatus, whereby the maintenance matters, repair matters, and the like for an automatic door apparatus in various locations can be consolidated, managed, and made into a database, and whereby access from the selling company or the maintenance company is possible.

In the method for managing an automatic door apparatus disclosed in Patent Literature 1, respective working information is transmitted, in association with identification information, to a management center from automatic door apparatuses in various locations, and the received working information is classified and accumulated for each one of the automatic door apparatuses by the management center on the basis of the identification information; the accumulated working information is outputted in response to a call condition.

Patent Literature 2 discloses an automatic door apparatus provided with a failure monitoring function whereby not only a failure site but also a cause for which the failure occurred can be investigated and whereby information relating to a failure can be extracted even when a CPU executing a self-diagnostic function fails.

The automatic door apparatus provided with the failure monitoring function disclosed in Patent Literature 2 is an automatic door apparatus for detecting the presence of an object with a sensor, in which a controller drives a door open/close mechanism motor to open/close a door on the basis of a signal outputted from the sensor, wherein the apparatus is provided with: an extracting means for extracting, from the controller, detection status information indicative of the detection status of the sensor as well as door status information indicative of the door open/close status in the detection status of the sensor, as working information; and a storing means for sequentially storing over time the working information extracted by the extracting means.

Patent Literature 3 discloses a remote monitoring device for an automatic door system for rapid maintenance of an automatic door system.

The remote monitoring device for the automatic door system disclosed in Patent Literature 3 comprises a plurality of automatic door systems provided with a controller for controlling the operation of an automatic door, wherein the automatic door systems are each provided with a self-diagnosing means for diagnosing a failure site in the automatic door system, and each of the self-diagnosing means transmits, to a maintenance center via a communication device, information indicative of in which automatic door system a failure has occurred in as well as a self-diagnosing means output representing the failure site, whenever an abnormality has occurred in the corresponding automatic door system.

### CITATION LIST

### Patent Literature

[PTL 1] Japanese Unexamined Patent Application Publication No. 2002-374583
[PTL 2] Japanese Unexamined Patent Application Publication No. 2003-91756
[PTL 3] Japanese Unexamined Patent Application Publication No. H11-247524

### SUMMARY OF INVENTION

### Technical Problem

A system of such description is able to ascertain the cause of a defect before going to an installation site in a case where the distance between a selling company or maintenance company and a customer location where the automatic door apparatus is installed is large, i.e., in a case where the maintenance company would take several hours or several tens of hours to move to the installation site of the automatic door apparatus; therefore, there is no need to go to the site again and again and a defect can be quickly resolved, which is very effective. In a case where a request to change an operating parameter occurs, too, a prompt solution is also possible, which is very effective.

However, in the method and system for managing an automatic door apparatus disclosed in Patent Literature 1, the selling company or maintenance company must have centralized management of information relating to the automatic door apparatuses of all customers. For this reason, there is a high volume of information that must be managed by the selling company or maintenance company, and a problem is likely to emerge in that the capacity of the recording device may become problematic or in that management costs, including backup, are considerable.

Also, security needs to be ensured for each of the automatic door apparatuses because it is possible to directly access each of the automatic door apparatuses of a customer, from the exterior.

An object of the present invention is to provide a management system for an automatic door with which it is possible to easily recognize the working circumstances of an automatic door apparatus and also possible to easily ensure security without incurring management costs for the selling company or the maintenance company.

### Solution to Problem

### 1

A management system for an automatic door apparatus according to a first aspect comprises: a plurality of automatic door apparatuses with which communication is possible, the apparatuses being disposed within a narrow-area network separated from a wide-area network via a router; a management computer capable of checking the working circumstances of each of the automatic door apparatus by communicating with the plurality of automatic door apparatuses, the management computer being disposed within the same narrow-area network as the automatic door apparatuses and information relating to the plurality of automatic door apparatuses being stored therein; and a first management terminal capable of communicating with the management computer via the wide-area network and the router, the first management terminal being disposed outside the narrow-area network; wherein the first management terminal is adapted to be able to remote-control the management computer.

In this case, a variety of information, including the working circumstances for each of the automatic door apparatuses of the customer, can be easily recognized from the first management terminal via the wide-area network. For example, the use of the first management terminal allows the selling company or maintenance company to remotely recognize a variety of information such as a maintenance history including the working circumstances of the automatic door apparatuses of the customer (whether or not the apparatuses are working properly, the setting circumstances for the operating parameters, and the error occurrence circumstances) and/or an operation history and/or a change history for the operating parameters. A selling company and/or maintenance company needs to maintain and manage an enormous number of automatic door apparatuses, and the working information and the like that need to be recorded relating to each individual automatic door apparatus are also immense. However, management information such as identification information for the automatic door apparatuses of the customer, or working information such as the open/close circumstances, is retained in the management computer of the customer, and therefore the selling company or maintenance company no longer needs to manage an immense about of data. As such, one part of the system will no longer be overloaded, and a balance can be achieved in the system overall. Various data is distributed and managed by each customer, and therefore an effect is also achieved in terms of data security. Furthermore, communication is not performed directly with the automatic door apparatuses from outside the narrow-area network; rather, communication with the automatic door apparatuses is performed via the management computer within the narrow-area network, and therefore security no longer needs to be ensured for each of the automatic door apparatuses. Merely ensuring the security of the management computer makes it possible to easily ensure the security within the narrow-area network.

### 2

A management system for an automatic door apparatus as set forth in a second embodiment preferably is configured such that in a management system for an automatic door apparatus according to one aspect, the management computer is capable of changing the operating parameters of the automatic door apparatuses.

In this case, because the operating parameters of the automatic door apparatuses can be changed by the management computer, there is no longer a need to travel to the installation site of the automatic door apparatuses. In particular in a case where the selling company or maintenance company is separated from the installation site of the automatic door apparatuses by a large distance and travel takes time, or in a case where many automatic door apparatuses have been provided in a large building, the loss of traveling to the installation site of the automatic door apparatuses is too great to be ignored, and thus there is a significant effect.

### 3

A management system for an automatic door apparatus as set forth in a third embodiment comprises: a plurality of automatic door apparatuses with which communication is possible, the apparatuses being disposed within a narrow-area network separated from a wide-area network via a router and being able to transmit an electronic mail to a pre-set transmission destination; a management computer which is disposed within the same narrow-area network as the automatic door apparatuses, is able to check working circumstances of each of the automatic door apparatuses by communicating with the plurality of automatic door apparatuses, information relating to the plurality of automatic door apparatuses being stored therein, and is able to receive an electronic mail; and a third management terminal which is disposed outside the narrow-area network, is able to receive an electronic mail transmitted from an automatic door apparatus, and is able to transmit an electronic mail to the management computer; wherein the management computer receives an electronic mail transmitted from the third management terminal and transmits, by an electronic mail to the third management terminal, the working circumstances of the automatic door apparatuses on the basis of the content thereof.

In this case, because the management computer can transmit working information relating to the automatic door apparatuses and the like by an electronic mail to the third management terminal, the selling company or maintenance company is able to remotely recognize a variety of information such as a maintenance history including the working circumstances of the automatic door apparatuses of the customer (whether or not the apparatuses are working properly, the setting circumstances for the operating parameters, and the error occurrence circumstances) and/or an operation history and/or a change history for the operating parameters. A selling company and/or maintenance company needs to maintain and manage an enormous number of automatic door apparatuses, and the working information and the like that needs to be recorded relating to each individual automatic door apparatus are also immense. However, management information such as identification information for the automatic door apparatuses of the customer, or working information such as the open/close circumstances, is retained in the management computer of the customer, and therefore the selling company or maintenance company no longer needs to manage an immense about of data. As such, one part of the system will no longer be overloaded, and a balance can be achieved in the system overall. Various data is distributed and managed by each customer, and therefore an effect is also achieved in terms of data security.

Further, because an electronic mail is used, in comparison to a case where the management computer is remotely operated, there is less concern of information leakage beyond the automatic door apparatuses as stored within the management computer, and greater security can be maintained.

### 4

A management system for an automatic door apparatus as set forth in a fourth embodiment preferably is configured such that in the management system for an automatic door apparatus as set forth in the third embodiment, the management computer allows for the operating parameters of the automatic door apparatuses to be changed only in a case where approval information has been outputted.

In this case, the output of approval information within the management computer, i.e., operation by a person possessing manager privileges makes it possible to change the operating parameters of the automatic door apparatuses, and thus changes to the operating parameters unbeknownst to the manager or changes not intended by the manager can be prevented.

### 5

A management system for an automatic door apparatus as set forth in a fifth embodiment preferably is configured such that in the management system for an automatic door apparatus as set forth in the third embodiment, the management computer allows for an electronic mail to be transmitted only in a case where approval information has been outputted.

In this case, the output of approval information within the management computer, i.e., operation by a person possessing manager privileges makes it possible to transmit the working information of the automatic door apparatuses and the like by an electronic mail, and thus information will not be transmitted unbeknownst to the manager nor will information not intended by the manager be transmitted.

### 6

A management system for an automatic door apparatus as set forth in a sixth embodiment preferably is configured such that in the management system for an automatic door apparatus according to one aspect or as set forth in the third embodiment, the system is disposed within the narrow-area network, a second management terminal is further provided, and the management computer is adapted to be capable of remote control by the second management terminal.

In this case, the working circumstances of the automatic door apparatuses can be checked by the second management terminal which is installed by the customer or the department responsible for management or the like, without the need to travel to the installation site of the automatic door apparatuses or of the management computer. For example, the second management terminal could conceivably be a personal computer as well as a smartphone or tablet or the like.

### 7

A management system for an automatic door apparatus as set forth in a seventh embodiment preferably is configured such that in the management system for an automatic door apparatus according to one aspect or as set forth in the third embodiment, the automatic door apparatuses are adapted to allow communication by TCP/IP.

In this case, communication between a management personal computer and the automatic door apparatuses is possible without the need for protocol conversion. Consequently, installation space and costs can be kept low.

### 8

A management system for an automatic door apparatus as set forth in an eighth embodiment preferably is configured such that in the management system for an automatic door apparatus according to one aspect or as set forth in the third embodiment, comprising automatic door apparatuses for which operating parameters can be changed by communication and a management computer capable of changing the parameters of the automatic door apparatuses, wherein the management computer is adapted to automatically change the operating parameters of the automatic door apparatuses on the basis of a predetermined condition.

In this case, the operating parameters of the automatic door apparatuses can be automatically changed on the basis of a predetermined condition set in the management computer even while the automatic door apparatuses remain structurally simple, and therefore a more fine-tuned control of the door opening/closing is possible.

### 9

A management system for an automatic door apparatus as set forth in a ninth embodiment preferably is configured such that in the management system for an automatic door apparatus as set forth in the eighth embodiment, the predetermined condition is a pre-set setting time, and the operations of the automatic door apparatuses are changed in accordance with the setting time.

In this case, a state of frequent ingress/egress or a state of infrequent ingress/egress is predicted in accordance with the time, an open/close condition for the automatic doors is set, and there can be a fine-tuned open/close door control which focuses on air conditioning efficiency or security.

The time herein can be set in accordance with the year, month, date, hour, minute, and second, or with the day of the week or season; the open/close mode comprises all or some of: an automatic door mode for opening and closing a door in accordance with a detection status from an automatic door sensor; a manual door mode for not opening/closing automatically; a fully-open mode for opening the door to a fully-open position; a half-open mode for opening and closing the door in accordance with the detection status from the automatic door sensor but where the opening width during opening is less than the fully-open width; a one-way mode in which the door is opened from one direction only; and a fully-close mode for maintaining a fully-close position irrespective of the detection status from the automatic door sensor. Possible operating parameters other than the open/close mode may also include the opening/closing speed of the automatic door apparatuses and the like.

### BRIEF DESCRIPTION OF DRAWINGS

FIG. 1 A schematic drawing for describing a management system for an automatic door apparatus according to a first embodiment of the present invention.

FIG. 2 A schematic drawing for describing an example of a display produced by a display.

FIG. 3 A schematic drawing for describing in greater detail a control setting scheduling display produced by the display illustrated in FIG. 2.

FIG. 4 A schematic drawing for describing in greater detail a setting display for a setting screen as well as for checking the door mode setting, the opening/closing format or other working aspects.

FIG. 5 A schematic drawing for describing a management system for an automatic door apparatus according to a second embodiment of the present invention.

### DESCRIPTION OF EMBODIMENTS

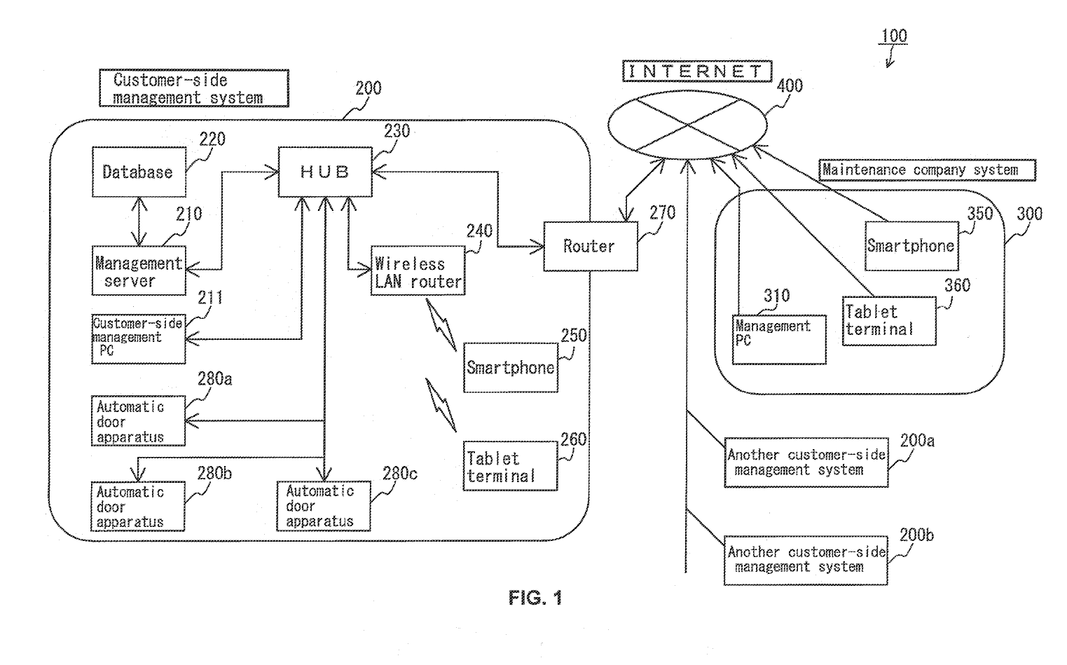

The following is a description of embodiments according to the present invention, with reference to the accompanying drawings. FIG. 1 is a schematic drawing for describing a management system 100 for an automatic door apparatus according to the present invention.

### (Overall Configuration)

As illustrated in FIG. 1, the management system 100 for an automatic door apparatus comprises: a customer-side management system 200; other customer-side management systems 200a and 200b; and a selling company or maintenance company system (hereinafter simply called a maintenance company system) 300.

The customer-side management systems 200, 200a, and 200b are connected to the maintenance company system 300 via Internet 400.

### (Customer-Side Management System)

The customer-side management system 200 is provided with a management server 210, a customer-side management PC (personal computer) 211, a database 220, a hub 230, a wireless LAN (Local Area Network) router 240, a smartphone 250, a tablet terminal 260, a router 270, and a plurality of automatic door apparatuses 280a, 280b, and 280c; these devices are arranged within a LAN belonging to the customer, the LAN being a narrow-area network. This local area network is connected to the Internet 400, which is a wide-area network, via the hub 230.

Herein, the smartphone 250 and the tablet terminal 260 are both provided with a display unit and an operation unit. Examples for the tablet terminal 260 include an Apple iPad, a Dell Streak, a JooJoo, a LuvPad, an Eee Pad, a Galaxy Tab, and a Modbook.

As will be described below, respective IP addresses are allocated to each of the automatic door apparatuses 280a, 280b, and 280c. In the present embodiment, the number of automatic door apparatuses 280a, 280b, and 280c is three, but there is no limitation thereto, and any other desired number thereof may also be provided.

The management server 210 of the customer-side management system 200 allows the database 220 to record the IP addresses allocated to the automatic door apparatuses 280a, 280b, and 280c, as well as the configuration information of devise and the like, the setting circumstances for operating parameters such as an open/close mode or an open/close speed, the number of open/close iterations and other accumulated information, the circumstances of accident occurrences, an change history for operating parameters, a history for handling accidents and other defects, and the like, for each one of the automatic door apparatuses.

### (Maintenance Company System)

The maintenance company system 300 comprises a management PC 310 which can be connected to the Internet 400, and a smartphone 350 or tablet terminal 360 which can be connected to the Internet 400 via a public wireless network (a mobile telephone network or a Wi-Fi network). Herein, the management PC 310, the smartphone 350, and the tablet terminal 360 are all provided with a display unit and an operating unit. Examples for the tablet terminal 360 include an Apple iPad, a Dell Streak, a JooJoo, a LuvPad, an Eee Pad, a Galaxy Tab, and a Modbook. The maintenance company system 300 has no database for recording information relating to the individual automatic door apparatuses. Information required for communication with the customer-side management system 200 via the Internet 400 (such as the global IP address and security code for the customer-side management system 200) is merely retained.

A person managing the customer-side management system 200 operates the management server 210 of the customer-side management system 200 illustrated in FIG. 1. The operated management server 210 acquires the working circumstances of the automatic door apparatuses 280a, 280b, and 280c, e.g., error information indicative of whether they are operating properly, the number of open/close iterations, the setting circumstances for the operating parameters, and the like, by communication via the hub 230. Herein, the management server 210 uses the IP addresses set for the automatic door apparatuses 280a, 280b, and 280c to connect to and communicate by TCP/IP with the automatic door apparatuses 280a, 280b, and 280c.

The operated management server 210, as shall be described below, sets the schedule for changing or controlling the open/close speed or other operating parameters for the automatic door apparatuses 280a, 280b, and 280c via the hub 230.

Instead of directly operating the management server 210, the manager of the customer-side management system 200 can also operate the customer-side management PC 211, the smartphone 250, or the tablet terminal 260 of the customer-side management system 200 illustrated in FIG. 1, as shall be described below. The operated customer-side management PC 211, smartphone 250, or tablet terminal 260 ascertains the working circumstances of the automatic door apparatuses 280a, 280b, and 280c via the management server 210.

The operated customer-side management PC 211, smartphone 250, or tablet terminal 260 can also set the schedule for controlling the automatic door apparatuses 280a, 280b, and 280c via the management server 210. A more detailed description of the setting of the control scheduling will follow.

### (Remote Operation)

The maintenance company operates the management PC 310 regularly or in a case where contact from a manager of the customer building has been received, and remotely operates management servers 210, 210b (not shown), 210c (not shown) of the customer-side management systems 200, 200a, and 200b via the Internet 400.

The maintenance company connects remotely to the management server 210 via the Internet 400 and the router 270 of the customer-side management system 200, using the management PC 310. The management server 210 receives a password from the management PC 310 of the maintenance company and performs a remote authentication. After authentication, the management server 210 can be remotely operated from the management PC 310. The management server 210 and the management PC 310 communicate with each other using VPN (Virtual Private Network) communication technology, but may also use another similar technology.

In a case where the management server 210 can be remotely operated, a display of the management PC 310 produces a display identical to what is displayed on a display of the management server 210; operations on the management PC 310, e.g., input from a keyboard or clicking done with a mouse are conveyed to the management server 210, and operation is as though there is directly control by the keyboard or mouse of the management server 210. In other words, remote desktop technology is used to operate the management server 210 from the management PC 310.

Remote desktop technology can also be used with the customer-side management PC 211, the smartphone 250, the tablet terminal 260, the smartphone 350, and the tablet terminal 360, to remotely operate the management server 210.

In this manner, rather than the automatic door apparatuses 280a, 280b, and 280c being accessed directly from outside the scope of the customer-side management system 200, the apparatuses can be accessed from the management PC 310, the smartphone 350, and the tablet terminal 360 only via the management server 210; therefore, the security of the customer-side management system 200 can be easily maintained. In particular, because there is no need for the automatic door apparatuses 280a, 280b, and 280c to be endowed with respective security functions, the size thereof need not be large and unnecessary expenses need not be incurred.

Because remote desktop technology is used to operate the management server 210, there is no need to develop management software for each one of the management PC 310, the smartphone 350, and the tablet terminal 360, thus obviating the need to expend efforts in development or to maintain and manage each individual management software program.

### (Door List Display)

An example of a display produced by the display of the management server 210 shall now be described. As mentioned earlier, in a case where remote operation is being performed, similar displays are produced by the display or the like of the customer-side management PC 211, the smartphone 250, the tablet terminal 260, the smartphone 350, and the tablet terminal 360. The following description relates to the display or operation of the management server 210, but in a case where remote operation is being performed, it will be readily understood that the same also applies to the customer-side management PC 211, the smartphone 250, the tablet terminal 260, the smartphone 350, and the tablet terminal 360.

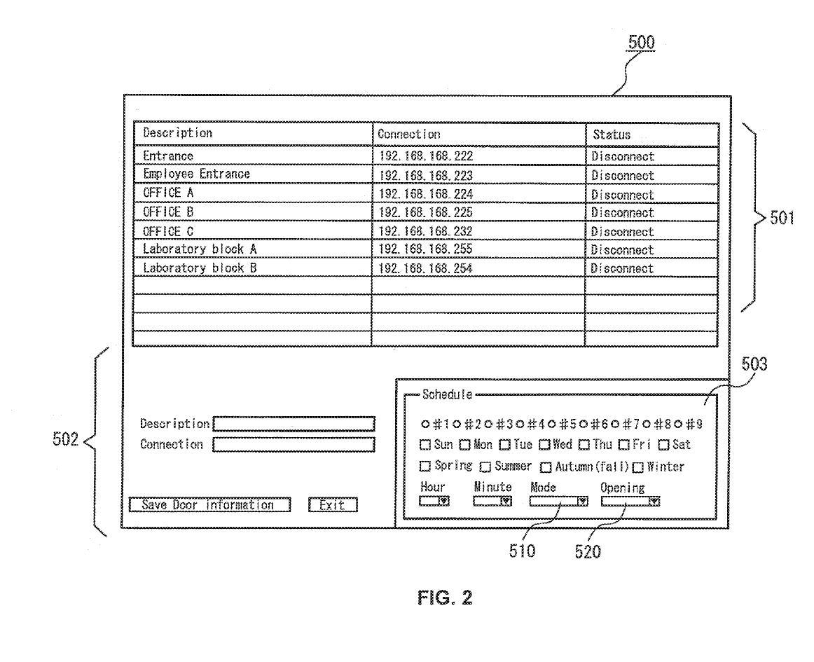

FIG. 2 is a schematic drawing for describing an example of a display produced by the display of the management server 210. This display is a display for checking the working circumstances or for setting the control schedule.

As illustrated in FIG. 2, the display of the management server 210 produces a display 500. The display 500 is one example of a door list display; the upper part comprises an automatic door apparatus catalog display 501, the lower left part comprises a correction checking display 502, and the lower right side comprises a control schedule display 503 for each of the automatic door apparatuses.

The automatic door apparatus catalog display 501 produces a display of names for the automatic door apparatuses, such as “entrance”, “office”, or “research building”, as well as the IP address for TCP/IP, the connection status, and the like.

The correction checking display 502 is provided with a box for selecting the IP address for TCP/IP as well as a door name.

The control schedule display 503 is provided with a check box for setting the control schedule. A more detailed description of the control schedule display 503 will follow.

Herein, the manager of the customer building or the maintenance company operates the management server 210 to check the names of the automatic door apparatuses, the IP addresses for TCP/IP, and the connection status, as displayed on the current automatic door apparatus catalog display 501.

In a case where a correction or change is to be made to the control schedule of one of the automatic door apparatuses, the manager clicks on the name of the automatic door apparatus, checks whether the name of the automatic door apparatus and the IP address for TCP/IP are displayed on the correction check display 502; in a case where they are displayed, the manager operates the check box of the control schedule display 503 to correct or change the control schedule of the automatic door apparatus.

Finally, a button on the correction check display 502 is operated to store the setting information.

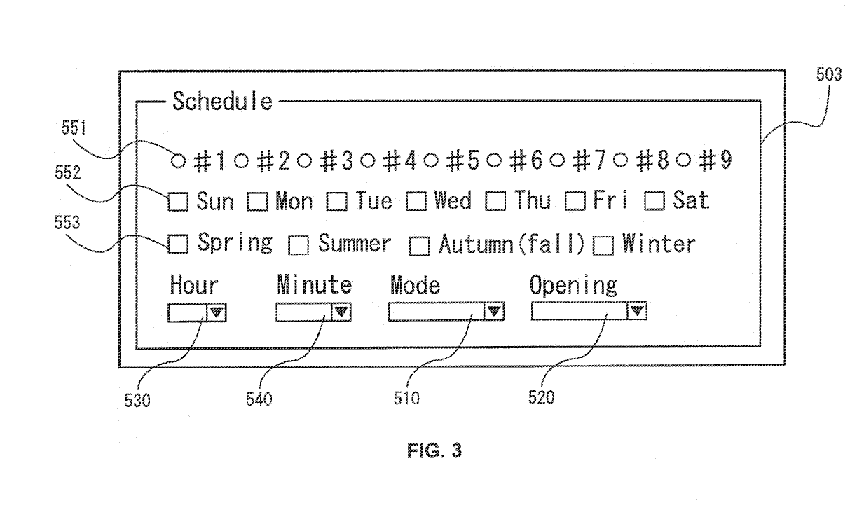

FIG. 3 is a schematic drawing for describing in greater detail the control schedule display 503 of the display 500 illustrated in FIG. 2.

As illustrated in FIG. 3, the control schedule display 503 comprises a door mode setting pull-down box 510, an open/close format pull-down box 520, an hour pull-down box 530, a minute pull-down box 540, a schedule number check box 551, a day-of-the-week check box 552, and a season check box 553.

Herein, the manager of the customer-side management system 200 or the maintenance company operates the management server 210 to operate the door mode setting pull-down box 510, the open/close format pull-down box 520, the hour pull-down box 530, the minute pull-down box 540, the schedule number check box 551, the day-of-the-week check box 552, and the season check box 553, and to set the operating parameters for each of the automatic door apparatuses 280a, 280b, and 280c.

For example, an office building or similar location has different amounts of foot traffic during the clock-in or clock-out time zone and during other time zones, and therefore a longer opening time can be taken for the clock-in/clock-out time zone and a shorter opening time can conversely be taken for other time zones. It will also be readily understood that settings can be changed depending on the season and, because the amount of foot traffic varies between weekdays and holidays, and settings can be made in accordance with the day of the week and the like. That is, the control schedules for the automatic door apparatuses can be set freely. The management server 210 recognizes the seasons or holidays on the basis of a calendar that is prepared separately.

In accordance with the content of the control schedule set in this manner, the management server 210 automatically communicates with the automatic door apparatuses 280a, 280b, and 280c to automatically change the settings for the operating parameters whenever a real-time clock or similar time-keeping means reaches a scheduled time. This manner of configuration removes the need to endow the automatic door apparatuses 280a, 280b, and 280c with a time-keeping means, a calendar function or the like and makes it possible to achieve a simpler configuration.

In the present embodiment, an example has been provided for the control schedule display 503 illustrated in FIG. 3, but not all of the display 503 is required and any one item or a plurality of items may be deleted or other items may be added.

### (Setting Screen and Work Checking for Door Mode and Open/Close Format)

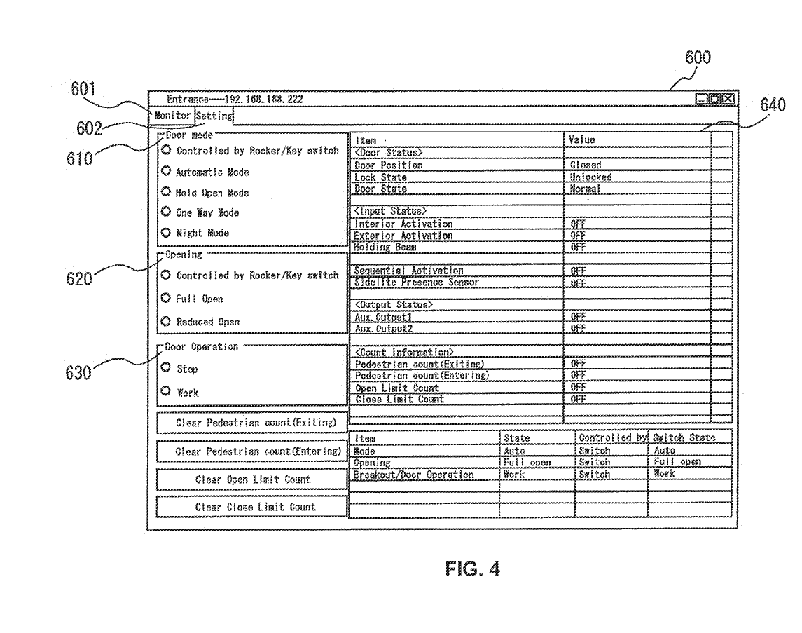

FIG. 4 is a schematic drawing for describing in greater detail a display for the door mode setting, which is one of the operating parameters, checking of operation of the opening/closing format or other working aspects as well as a setting screen.

A setting display 600 illustrated in FIG. 4 is displayed on the display of the management server 210 in a case where an entrance in the automatic door apparatus catalog display 501 illustrated in FIG. 2 has been double-clicked.

The setting display 600 illustrated in FIG. 4 comprises a monitor screen selection 601, a setting screen selection 602, a door mode setting 610, an open/close format setting 620, an automatic door control setting 630, a number of passers-through (direction of ingress), a number of passers-through (direction of egress), and current automatic door operating circumstances display 640.

Herein, the manager of the customer-side management system 200 or the maintenance company operates the management server 210 to select either the monitor screen selection 601 or the setting screen selection 602. For example, the monitor screen selection 601 is selected in a case where the working circumstances of the automatic door apparatus 280a is to be checked, and the setting screen selection 602 is selected in a case where settings are to be performed for the automatic door apparatus 280a.

The check boxes for the door mode setting 610, the open/close format setting 620, and the automatic door control setting 630 are provided so as to be selectable only in a case where the setting screen selection 602 has been selected.

The door mode setting 610 comprises: a mode for opening and closing with a switch in the vicinity of the automatic door apparatus; a mode for opening and closing on the basis of a detection result from a sensor belonging to the automatic door apparatus; a continuous fully-open mode for keeping the door of the automatic door apparatus fully opened; a continuous fully-close mode for keeping the door of the automatic door apparatus fully closed; a one-way mode at night; and the like. The one-way mode at night refers to a mode where passage from the indoor direction to the outdoor direction is possible but passage from the outdoor direction to the indoor direction is not possible.

Next, the open/close format setting 620 comprises a fully-open format, a half-open format, and an open/close format controlled with a switch in the vicinity of the automatic door apparatus.

The door of the automatic door apparatus 280a is set to be fully open (the door opens such that substantially the entire width of the through-passage opening is open) during time zones when there is heavy foot traffic of people walking through. The door of the automatic door apparatus 280a is set to be half open (the door opens such that only some, e.g., half, of the width of the through-passage opening is open) during time zones when there is light foot traffic of people walking through. This makes it possible to adjust the amount of indoor/outdoor ventilation and easily maintain the room temperature or the like indoors.

In the present embodiment, although examples are given for the fully-open format, the half-open format, and the open/close format controlled with a switch, there is no limitation thereto, and a one-quarter open/close format, three-quarters open/close format, or other desired open/close format may also be used.

Next, the automatic door control setting 630 in FIG. 4 comprises an operating setting for automatic opening/closing as well as a stop setting whereby manual opening/closing is possible but automatic opening/closing is not. Settings for other operating parameters of the automatic door apparatus, such as the opening speed or the closing speed, may also be made.

### Second Embodiment

The following is a description of points whereby a second embodiment differs from the first embodiment. In the following description, an “electronic mail” may in some cases refer merely to an e-mail.

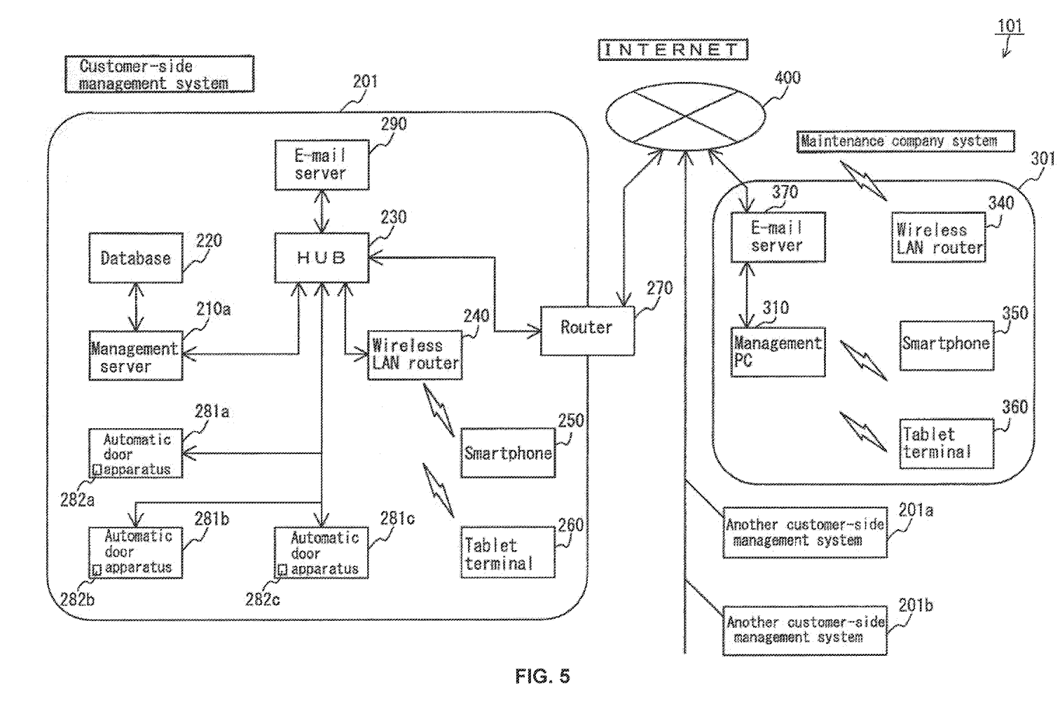

FIG. 5 is a schematic drawing for describing a management system 101 for an automatic door apparatus according to the second embodiment of the present invention. The following description relates to points whereby the management system 101 illustrated in FIG. 5 differs from the management system 100 illustrated in FIG. 1, and a description has been omitted for points of similarity. In the management system 101 for an automatic door apparatus, the router 270 is set so as to disallow remote operation. That is, a remote connection to a customer-side management system 201 from a maintenance company system 301 is not possible in the present state.

Other customer-side management systems 201a and 201b in the management system 101 illustrated in FIG. 5 are systems that correspond to the other customer-side management systems 200a and 200b in FIG. 1, and, similarly with respect to the description above, a remote connection to the customer-side management systems 201a and 201b from the maintenance company system 301 is not possible in the present state.

### (Customer-Side Management System)

The customer-side management system 201 comprises an e-mail server 290 in addition to the constituent elements of the customer-side management system 200 in FIG. 1. The e-mail server 290 is connected to the hub 230. A management server 210a corresponds to the management server 210, and automatic door apparatuses 281a, 281b, and 281c correspond to the automatic door apparatuses 280a, 280b, and 280c.

As will be described below, the management server 210a and the automatic door apparatuses 281a, 281b, and 281c each are provided with an e-mail client function (a function for using the SMTP protocol or the like to transmit and receive electronic mails to/from the e-mail server. Hereinafter, the same applies). The management server 210a has all of the functions of the management server 210, other than the remote connection function, and the automatic door apparatuses 281a, 281b, and 281c have all of the functions of the automatic door apparatuses 280a, 280b, and 280c.

### (Maintenance Company System)

The maintenance company system 301 illustrated in FIG. 5 is the maintenance company system 300 in FIG. 1 but further comprising an e-mail server 370. The e-mail server 370 is connected to the management PC 310 using a hub (not shown) or the like.

As will be described below, the management PC 310, the smartphone 350, and the tablet terminal 360 in FIG. 5 as well as the customer-side management PC 211 (not shown) are each provided with the e-mail client function.

### (E-Mail Notification)

The automatic door apparatuses 281a, 281b, and 281c illustrated in FIG. 5 transmit e-mails to a pre-set e-mail address via the e-mail server 290 within the customer-side management system 201.

This e-mail address belongs to the manager of the customer-side management system 201, the maintenance personnel of the maintenance company system 301, or the like. A more detailed description is provided below.

This e-mail address is pre-set when the automatic door apparatuses 281a, 281b, and 281c are constructed, during maintenance work, or at a similar time.

The content of the e-mail transmissions comprises positional information indicative of the locations of the automatic door apparatuses 281a, 281b, and 281c, as well as error information, the number of open/close iterations, operating parameter settings, and other information indicative of some or all of the working circumstances of the automatic door apparatuses 281a, 281b, and 281c, e.g., of whether or not they are operating properly.

E-mail is transmitted on a regular basis, e.g., once at a certain time of day. E-mail may also be transmitted when the automatic door apparatuses 281a, 281b, and 281c have a failure or abnormality, or when buttons 282a, 282b, 282c (not shown) provided in the vicinity of the automatic door apparatuses 281a, 281b, and 281c, e.g. under a transom or on a wall surface, are pressed.

In a case where an e-mail transmission sent from the automatic door apparatuses 281a, 281b, and 281c is addressed to a manager, the e-mail server 290 within the customer-side management system 201 provides notification of an incoming e-mail for the customer-side management PC 211, the smartphone 250, tablet terminal 260, or the like provided with an e-mail client function which is carried by the respective manager.

Consequently, the manager can ascertain the working circumstances of the automatic door apparatuses 281a, 281b, and 281c. A prompt response when a failure or abnormality occurs is also possible.

Meanwhile, in a case where an e-mail transmission sent via the mail server 290 from the automatic door apparatuses 281a, 281b, and 281c is addressed to maintenance personnel, the e-mail server 370 of the maintenance company system 301 provides notification of an incoming e-mail, transmitted from the mail server 290, for the management PC 310 used by the maintenance personnel or for the smartphone 350, tablet terminal 360, or the like held by the maintenance personnel.

Consequently, the maintenance personnel can ascertain the working circumstances of the automatic door apparatuses 281a, 281b, and 281c. A prompt response when a failure or abnormality occurs is also possible, and the manager can be contacted.

### Third Embodiment

The following is a description of points whereby a third embodiment differs from the first embodiment and the second embodiment. The third embodiment is also described with reference to FIG. 5.

The following description relates to points whereby the management system 101 illustrated in FIG. 5 according to the third embodiment differs from the management system 100 and management system 101 illustrated in FIGS. 1 and 5 according to the first embodiment and the second embodiment, and a description has been omitted for points of similarity.

The third embodiment adopts a configuration identical to the overall configuration of the management system 101, the customer-side management system 201, and the maintenance company system 301, according to the second embodiment.

Firstly, the maintenance personnel in the maintenance company system 301 uses the smartphone 350 or the tablet terminal 360 to transmit an e-mail.

In this case, the electronic mail transmitted from the smartphone 350 or the tablet terminal 360 is received by the management server 210a of the customer-side management system 201 after having passed through the e-mail server 370 and the e-mail server 290 of the customer-side management system 201. The content of the e-mail is an information verification described below.

Next, the management server 210a, after receipt of the e-mail, automatically transmits an e-mail for checking whether or not the maintenance personnel has authorization for information verification, addressed to the manager of the customer-side management system 201. This e-mail transmission comprises a plurality of patterns.

### (Pattern 1)

More specifically, an e-mail to request authorization to verify information is transmitted to the smartphone 350, tablet terminal 360, customer-side management PC 211 or the like belonging to the manager, and in a case where the manager approves the request, an e-mail indicative of the same is transmitted to the management server 210a. In a case of denial, an e-mail indicative of the same is similarly transmitted to the management server 210a. The e-mail may also be transmitted by clicking on a link embedded in the e-mail (HTML format).

### (Pattern 2)

In the other pattern, firstly, an e-mail to request approval for information verification is transmitted to the smartphone 350, tablet terminal 360, or customer-side management PC 211 belonging to the manager.

The manager, having received an e-mail notification, travels to the installation site of the management server 210a and directly operates the management server 210a (for example, by clicking on a specific button) to thereby either approve or deny the request.

Herein, an “information verification” signifies the transmission of the type or installed number of automatic door apparatuses 281a, 281b, and 281c, the setting values for the operating parameters, or information either recorded in a database 220, such as an operation history, or newly acquired from the automatic door apparatuses 281a, 281b, and 281c.

Next, the e-mail transmission or direct operation according to pattern 1 or pattern 2 causes the management server 210a to send a transmission via the e-mail servers 290 and 370 indicating that this information has been delivered to the smartphone 350, tablet terminal 360, or management PC 310 of the maintenance personnel in the maintenance company system 301.

Consequently, the maintenance personnel is able to reliable obtain information. Because there is no direct entry into the local area network of the customer-side management system 201, the security in the management server 210a of the customer-side management system 201 can also be maintained.

(Changing the open/close speed and other parameters of automatic door apparatuses 281a, 281b, and 281c, or changing the settings for the control schedule.)

The maintenance personnel transmits an e-mail comprising a setting value to be changed to the management server 210a from the smartphone 350 or the tablet terminal 360 via the e-mail server 370, or from the management PC 310 via the e-mail server 370 and the e-mail server 290.

The management server 210a automatically transmits an e-mail transmission for confirming whether or not changing the setting is permitted, addressed to the manager. For example, the management server 210a transmits an e-mail to the smartphone 350, tablet terminal 360, or customer-side management PC 211 belonging to the manager, via the e-mail server 290.

The manager uses the smartphone 350, tablet terminal 360, or customer-side management PC 211 to reply to the management server 210a an e-mail indicating that changing the setting is permitted. Alternatively, the manager directly operates the management server 210a (for example, by clicking on a specific button). Consequently, the management server 210a operates so as to change the setting value for the automatic door apparatuses 281a, 281b, and 281c.

As per the foregoing, the working circumstances of the automatic door apparatuses 280a, 280b, and 280c or automatic door apparatuses 281a, 281b, and 281c of the customer (hereinafter, referred to in general as “the automatic door apparatuses 280a, 280b, 280c and the like”) can be easily checked, without the need to go to the installation site, from the management PC 310 via the maintenance company system 300 or the maintenance company system 301 and the Internet 40, or via the management server 210 or management server 210a (hereinafter, referred to in general as “the management server 210 or the like”).

Although the selling company or maintenance company manages an enormous number of automatic door apparatuses 280a, 280b, 280c and the like, the management information relating to the automatic door apparatuses 280a, 280b, 280c and the like of the customer, such as identification information, or the open/close circumstances or other working information is stored in the database 220 of the management server 210 or the like of the customer. Accordingly, it is no longer necessary for the selling company or maintenance company to manage an enormous amount of data, and therefore the systems of the selling company or the maintenance company can be simplified. In other words, the smartphone 350 or tablet terminal 360, which have less storage capacity, can still be used, and even when the maintenance personnel has gone out of the office, it is still possible to check the state of different automatic door apparatuses or to adjust the control settings.

Furthermore, because information relating to the automatic door apparatuses of the customer, like management information, working information, or the like is distributed to and managed by each customer, the present invention is also advantageous in terms of data security.

Further, rather than there being direct communication with the automatic door apparatuses 280a, 280b, 280c and the like from outside the customer-side management system 200 or customer-side management system 201 (hereinafter, referred to in general as the “customer-side management system 200 or the like”), there is communication with the automatic door apparatuses 280a, 280b, 280c and the like via the management server 210 or the like within the customer-side management system 200 or the like, and therefore security within the customer-side management system 200 or the like can be easily maintained and managed.

Also, because the operating parameters for the automatic door apparatuses 280a, 280b, 280c and the like can be changed from the management PC 310 via the management server 210 or the like or from the management server 210 or the like, there is no longer a need for maintenance personnel to travel to the installation site of the automatic door apparatuses 280a, 280b, 280c and the like in order to change the operating parameters.

In particular in a case where the selling company or maintenance company is separated from the installation site of the automatic door apparatuses 280a, 280b, 280c and the like by a large distance and travel takes time, or in a case where many automatic door apparatuses 280a, 280b, 280c and the like have been provided in a large building, the loss of traveling to the installation site of the automatic door apparatuses 280a, 280b, 280c and the like is too great to be ignored, and thus there is a significant effect.

Because an IP address is allocated to the automatic door apparatuses 280a, 280b, 280c and the like and communication is done by TCP/IP, direct or indirect communication between management server 210 or the like and the automatic door apparatuses 280a, 280b, 280c and the like is possible without the need for protocol conversion. Consequently, installation space and costs can be kept low. Because the control schedule function makes it possible to automatically change the operating parameters of the automatic doors on the basis of the condition set for the management server 210 or the like, while the automatic door apparatuses 280a, 280b, 280c and the like remain structurally simple, a more fine-tuned door open/close control can be easily implemented.

It is also possible to check the working circumstances of the automatic door apparatuses 280a, 280b, 280c and the like without the need to travel to the installation site of the automatic door apparatuses 280a, 280b, 280c and the like or of the management server 210 or the like, using the customer-side management PC 211, the smartphone 250, or the tablet terminal 260 installed for the customer or the department responsible for management or the like.

The operating parameters for the automatic door apparatuses 280a, 280b, 280c and the like are set in accordance with the day of the week or time zone where ingress/egress of foot traffic is heavy or light, thus making it possible to have a fine-tune door open/close control that emphasizes air conditioning efficiency or security.

In the first embodiment, the description relates to a case where remote desktop technology is used, but there is no limitation thereto, and remote operation may also be possible using any other desired technique, or a Web server or CGI or a similar server-side scripting technology together. The control schedule was set using the day of the week or the time, but an automatic setting can also be done irrespective of the day of the week or the time zone, on the basis of, for example, information from a sensor for detecting passageway congestion or information relating to an event being held or the like.

In the second and third embodiments, the management server 210a is able to use an electronic mail to transmit the working information and the like of the automatic door apparatuses 281a, 281b, and 281c via the e-mail servers 290 and 370.

Because an electronic mail is used, there is no concern of information leakage beyond the automatic door apparatuses 281a, 281b, and 281c as stored within the management server 210a, and greater security can be maintained.

Also, because the working information and the like relating to the automatic door apparatuses 281a, 281b, and 281c can be transmitted and the operating parameters can be changed by e-mail on the basis of approval information, i.e., upon approval by a person possessing manager privileges, it is possible to prevent the transmission of information or changing of settings unbeknownst to the manager or not intended by the manager.

Herein, the Internet 400 is equivalent to the wide-area network, the router 270 is equivalent to the router, the customer LAN is equivalent to the narrow-area network, the automatic door apparatuses 280a, 280b, and 280c are equivalent to the automatic door apparatuses, the management servers 210 and 210a are equivalent to the management computer, the e-mail servers 290 and 370 are equivalent to the third management terminals, the management PC 310 is equivalent to the first management terminal, and the customer-side management PC 211, the smartphone 250, and the tablet terminal 260 are equivalent to the second management terminal.

The preferred embodiment for carrying out the present invention is as per the foregoing, but the present invention is not limited thereto. It will be readily understood that there are a variety of other embodiments which will not depart from the spirit and scope of the present invention. The present embodiments describe the actions and effects of the configuration of the present invention, but these actions and effects are an example and do not limit the present invention.
100, 101 Management system for automatic door apparatus
200, 201 Customer-side management system
210, 210a Management server
211 Customer-side management PC
230 Hub
250 Smartphone
260 Tablet terminal
270 Router
280a, 280b, 280c, 281a, 281b, 281c Automatic door apparatus
300, 301 Maintenance company system
310 Management PC
350 Smartphone
360 Tablet terminal

1. A management system for an automatic door apparatus, the system characterized by comprising:
a plurality of automatic door apparatuses with which communication is possible, the apparatuses being disposed within a narrow-area network separated from a wide-area network via a router;
a management computer capable of checking the working circumstances of each of the automatic door apparatuses by communicating with said plurality of automatic door apparatuses, the management computer being disposed within the same narrow-area network as said automatic door apparatuses and information relating to said plurality of automatic door apparatuses being stored therein; and
a first management terminal capable of communicating with the management computer via said wide-area network and said router, the first management terminal being disposed outside said narrow-area network, wherein
said first management terminal is adapted to be able to remote-control said management computer.

2. The management system for an automatic door apparatus according to claim 1, characterized in that said management computer is able to change the operating parameters of said automatic door apparatuses.

3. The management system for an automatic door apparatus according to claim 1, characterized in that
said management system is disposed within said narrow-area network and further comprises a second management terminal, and
the management computer is adapted so as to be remote-controllable using said second management terminal.

4. The management system for an automatic door apparatus according to claim 1, characterized in that said automatic door apparatuses are adapted to enable communication by TCP/IP (Transmission Control Protocol/Internet Protocol).

5. The management system for an automatic door apparatus according to claim 1, characterized by comprising: automatic door apparatuses for which operating parameters can be changed by communication; and a management computer capable of changing the parameters of said automatic door apparatuses, wherein
said management computer is adapted to automatically change the operating parameters of said automatic door apparatuses on the basis of a predetermined condition.

6. The management system for an automatic door apparatus according to claim 5, characterized in that said predetermined condition is a pre-set setting time and the operation of the said automatic door apparatuses is changed in accordance with said setting time.

7. A management system for an automatic door apparatus, the system being characterized by comprising:
a plurality of automatic door apparatuses with which communication is possible, the apparatuses being disposed within a narrow-area network separated from a wide-area network via a router and being able to transmit an electronic mail to a pre-set transmission destination;
a management computer which is disposed within the same narrow-area network as said automatic door apparatuses, is able to check working circumstances of each of the automatic door apparatuses by communicating with said plurality of automatic door apparatuses, information relating to said plurality of automatic door apparatuses being stored therein, and is able to receive said electronic mail; and
a third management terminal which is disposed outside said narrow-area network, is able to receive an electronic mail transmitted from said automatic door apparatuses, and is able to transmit an electronic mail to said management computer, wherein
said management computer receives an electronic mail transmitted from said third management terminal and transmits, in an electronic mail to said third management terminal, the working circumstances of said automatic door apparatuses on the basis of the content thereof.

8. The management system for an automatic door apparatus according to claim 7, characterized in that said management computer is able to change the operating parameters of said automatic door apparatuses only in a case where approval information has been outputted.

9. The management system for an automatic door apparatus according to claim 7, characterized in that said management computer is able to transmit said electronic mail only in a case where approval information has been outputted.

10. The management system for an automatic door apparatus according to claim 7, characterized in that
said management system is disposed within said narrow-area network and further comprises a second management terminal, and
the management computer is adapted so as to be remote-controllable using said second management terminal.

11. The management system for an automatic door apparatus according to claim 7, characterized in that said automatic door apparatuses are adapted to enable communication by TCP/IP (Transmission Control Protocol/Internet Protocol).

12. The management system for an automatic door apparatus according to claim 7, characterized by comprising: automatic door apparatuses for which operating parameters can be changed by communication; and a management computer capable of changing the parameters of said automatic door apparatuses, wherein
said management computer is adapted to automatically change the operating parameters of said automatic door apparatuses on the basis of a predetermined condition.

13. The management system for an automatic door apparatus according to claim 12, characterized in that said predetermined condition is a pre-set setting time and the operation of the said automatic door apparatuses is changed in accordance with said setting time.
